(19) United States
(12) Patent Application Publication
(10) Pub. No.: US 2008/0228507 A1
(43) Pub. Date: Sep. 18, 2008

(54) RETAIL PUBLISHING SYSTEM, METHOD, PROGRAM, AND APPARATUS

(76) Inventors: PAUL LARUE, BRENTWOOD, TN (US); COLE YOUNG, NASHVILLE, TN (US); CHRIS RILEY, NASHVILLE, TN (US)

Correspondence Address: ADVANTIA LAW GROUP, 9035 SOUTH 1300 EAST, SUITE 200, SANDY, UT, 84094, US

(21) Appl. No.: 11/686,294

(22) Filed: Mar. 14, 2007

(51) Int. Cl. G06Q 10/00

(52) U.S. Cl. 705/1

(57) ABSTRACT

A retail publishing system, method, program, and apparatus for enabling desktop publishing in a retail setting. The system comprises: a media content provider network that provides media content from a plurality of sources; a media content management module that selectably restricts access to the media content provider network; a media manufacturing apparatus that produces a media token with media disposed thereon; a media publishing module that delivers selected media to the media manufacturing apparatus; a media licensing module manages access to the media content provider network; and a media purchasing module that enables a user to purchase media. The method comprises the steps of: providing a publishing module having access to a media provider network through a media licensing module; providing a media manufacturing apparatus configured to manufacture a media token according to publishing instructions from the publishing module; and restricting media visibility from the media provider network to the publishing module.

### CROSS-REFERENCE TO RELATED APPLICATIONS

This invention claims priority, under 35 U.S.C. § 120, to the United States Provisional Patent Application titled “POSM” that was filed on or about March 2006 to Paul Larue, Cole Young, and Chris Riley which is incorporated by reference herein.

### BACKGROUND OF THE INVENTION

1. Field of the Invention

The present invention relates to retail publishing systems and methods, specifically a system, method, program, and apparatus enabling desktop publishing in a retail setting.

2. Description of the Related Art

State-of-the-art computer, electronic, satellite, and digital technology is emerging rapidly in the modem day retail marketplace. This emergence affords consumers the opportunity to conveniently order and purchase multi-media products from retailers, without the assistance of retail clerks, cashiers, etc. Examples of such products that may be obtained, include, but are not limited to: art, music, videos, gaming devices, television/news programs, electronic books, educational games/programs for children, etc. conveniently through the world-wide web, computer, and other electronic means. In today's fast paced society, consumers are seeking for a quicker way to purchase media products for entertainment without having to wait in long lines at conventional brick and motor retail establishments in order to purchase such products. As an alternative, consumers have the option of quickly purchasing media products from vending machines, business-to-consumer (B2C) websites, on-demand media delivery systems, and other point of sale mediums without assistance from retail salespeople.

As technology continues to advance, the capabilities of electronic devices available in the marketplace have evolved to the point where consumers may employ computer technology such as clip art, compact diskette (CD), digital audio tape (DAT), digital video diskette (DVD), video recorders and combinations thereof, either at their place of residence or a retail store location, in order to purchase personalized or customized media products such as greeting cards, music CDs/DVDs, electronic books, etc. and other sources of entertainment. The availability of such technology alleviates the consumer from being forced to purchase pre-packaged multi-media products containing less than desired content thereon.

However, there are many retailers that carry excess supply of media devices and other products at their locations, especially during times when consumer demand for a product shifts or changes in response to an ever changing marketplace. In response to this reality, many retailers are unable to control or modify inventory levels relatively fast manner. For example, many retailers experience inventory management challenges, especially in the music and video game industries, which are characterized by high consumer demand for popular “hit” titles for only a brief period of time. When consumer demand for said titles diminishes, and corresponding overstock of inventory at a retail location occurs, this can be a problem to both retailers and producers/suppliers of music and video software titles/content. For the retailer, this results in the loss of significant sales revenue due to producing/distributing an “obsolete” title for which there is no consumer demand. As for the producers/suppliers, many of them maintain policies of “buying back” or accepting return of goods without penalty of all or a portion of overstocked inventory or providing credits towards future product purchases by retailers.

Further, the prior art technology incorporated by reference herein fail to address the need for a system or method that treats the retailer as a consumer and/or enables a retailer to employ automated means to quickly abandon a product from its inventory in order to meet dynamic business models/strategies. For example, a retailer in the drug and medicine industry may discover that an over-the-counter drug product it sold to consumers on behalf of a drug supplier in its distribution channel may receive negative press through the media (e.g., television, radio, news, etc.) based on negative health effects experienced by consumers that purchased the affected drug. In response, the retailer may opt to no longer carry said drug product at its location so as not to tarnish its business reputation in the community. Therefore, the retailer may quickly restrict or discontinue any further electronic transmission of advertisements/promotions of the drug product to its location, thereby restricting access to any information pertaining to the drug from any consumers desiring to purchase drugs or the like. Some improvements have been made in the field. Examples include, but are not limited to, the references described below, which references are incorporated by reference herein:

U.S. Pat. No. 5,036,472, issued to Buckley et al., discloses a machine for vending greeting cards or other personalized or customized products includes audio and video presentations of available products and options available to a customer, provisions for payment and apparatus for automatic delivery of products. Base products such as preprinted forms are stored for selective transfer by a robot device to modifying apparatus such as a printer, modified products being delivered to a delivery receptacle, all operations being under computer control and being changeable as desired for adding or substituting new forms of products.

U.S. Pat. No. 5,418,654, issued to Scheffler, discloses a customized album recording system is under the control of a central microprocessor or mini-computer. A master library or storage medium is filled with a repertoire of recorded information items (such as musical selections) which may originate with any suitable source, such as phonograph records, tapes, sound tracks, compact discs, or the like. Each information item is stored in the library under its own address. On read out, an operator keys in the addresses identifying the selected items which are read out of the library medium and stored in a large capacity memory, usually to provide about forty-five minutes of total listening time. Then, all of the music is read out of that large capacity memory and recorded at a high speed onto a suitable album size medium, such as a tape cassette, for example. The source music and the customized album music are usually recorded in an analog form. The music which is processed within the system is in a digital form. Thus, the various transfers of music from the master storage to the recorded album may be accomplished at a high speed of digital transmission. In an alternative embodiment, instead of reading out an entire album amount of recorded information items, the central computer successively reads out limited amounts of data on a demand and fetch basis. A computer provides both the analog-to-digital and the digital-to-analog conversions in order to improve fidelity.

U.S. Pat. No. 5,418,713, issued to Allen, discloses an on demand data delivery system is provided for the manufacture of original content recordings at a remote location. A data capture facility for retrieving data from an item of material is connected to a data resampling means for compressing data which is accessible to a storage facility connected to a central host server. The central host server is connected to a communications network for communication to a remote server which controls a manufacturing control device connected thereto. The manufacturing control device duplicates original content recordings on blank media upon receipt of a data representation of the original content recording from the remote server which retrieves said data representation for a selected original content recording from the central host server over the communications network.

U.S. Pat. No. 5,592,511, issued to Schoen et al., discloses a system for creation of user-selected customized audio products, defined as a plurality of songs from different recording artists recorded on a single compact disc (CD) or digital audio tape (DAT) cassette, at record store/distributor locations utilizing a digitized, central database with production hardware at distributor sites. Customized products consist of CD ROM or digital audio tapes (DAT) with music or voice content selected from large digital database, and are written at local workstations at distribution centers (such as record stores) which are connected by a high-speed communications network. The system records costs of the digitized audio (e.g., royalties for individual songs) for billing purposes, as well as producing descriptive material (contents, background information, and graphics for labels, etc.). Data transfer and production is faster than real-time. The system consists of integrated, state-of-the-art digital databases, communications networks, computer workstations, and unique workstation processing software, and provides an innovative product/service (individual customized albums or audio data compilations) which currently do not exist.

U.S. Pat. No. 6,330,490, issued to Kim et al., discloses a data vending machine system and a method thereof, and in particular to a data vending machine system and a method thereof which are capable of selecting a certain music file, recording the selected music file onto a recording medium and printing a selected image and character message on a surface of the recording medium. The present invention includes a host computer for storing a digital music file and a plurality of remote data vending machine connected with the host computer. The data vending machine includes at least one listing and reserving apparatus for providing a reservation function of the music files selected by the customer, a database and fabrication control apparatus for storing a part of the music files stored in the host computer and recording the selected music file onto the recording medium, and a charge paying unit. There are further provided a main apparatus which performs the entire control operation of the data vending machine so that the music files selected by the customer is fabricated as one music album, and a network apparatus.

The inventions heretofore known suffer from a number of disadvantages which include: providing consumers with limited freedom in making media; being unable to allow retail entities to selectably restrict access to illegal/unwanted media types, genres, artists, labels, copyright holders, license terms, and/or according to any other characteristic of the media that is not aligned with its business goals; being unable to be tailored in response to changing business/marketing strategies of the retail entity; and/or otherwise lacking the ability to provide the retail entity with controls and tools for establishing and controlling supply of inventory needed to maintain or achieve competitive advantage in the marketplace.

What is needed is a retail publishing system, method, program, and apparatus that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available retail publishing systems and methods. Accordingly, the present invention has been developed to provide a system, method, program, and apparatus that enable desktop publishing in a retail setting.

There is an embodiment of a retail publishing system, program, and apparatus for enabling desktop publishing in a retail setting that includes, but is not limited to: a media content provider network that may be configured to provide media content from a plurality of sources; a media content management module in communication with the media content provider network and may include a selectable rule having a mode wherein access to the media content provider network is restricted; a media manufacturing apparatus in communication with the media content management module and may be configured to receive media therefrom and/or produce a media token having media disposed thereon; and/or a media publishing module in communication with the media content management module that may provide access to media from the media content provider network and/or enable selection of media thereby forming media selection information deliverable to the media manufacturing apparatus.

One embodiment of the system further includes: a media licensing module in communication with the media content provider network that may be configured to manage access to the media content provider network; and a media purchasing module in communication with the media licensing module that may be configured to receive media selection information and/or enable a purchase thereof.

According to another embodiment of the present inventive system, it may be that the media content management module may include a selectable rule that restricts access to the media content provider network according to a characteristic from the list of characteristics including time, date, genre, rating, artist, and license holder.

According to yet another embodiment of the present inventive system, the media publishing module includes a publishing rule that may have a mode wherein a required media must be included in the media selection information.

According to yet a further embodiment of the present inventive system, the media publishing module may enable modification of media and/or produce modified media information.

According to still yet a further embodiment of the present inventive system, there is a media purchasing module in communication with the media publishing module and may be configured to enable a consumer to purchase media according to publishing information.

In addition to the retail publishing system, program, and apparatus, there is an embodiment of a retail publishing method, comprising the steps of: providing a publishing module that may have access to a media provider network through a media licensing module; providing a media manufacturing apparatus in communication with the publishing module that may be configured to manufacture a media token according to publishing instructions from the publishing module; and restricting media visibility from the media provider network to the publishing module.

In one embodiment of the present invention, the method of retail publishing further comprises a step that may require inclusion of a media element in publishing instructions, wherein the media element may not be hidden when included in the media token.

In another embodiment of the present invention, the method of retail publishing may further comprise a step of providing a media purchasing module that may restrict access to the media manufacturing module.

In yet another embodiment of the present invention, the method of retail publishing may comprise the steps of: altering media visibility between the media provider network and/or the publishing module; and/or altering a required media element.

In yet a further another embodiment of the present invention, the method of retail publishing may further comprise a step of: providing a media content management module in communication with a media licensing module that may include a selectable rule having a mode wherein access to the media content provider network may be restricted.

It may be the present inventive method of retail publishing includes a step of providing a kiosk in a retail establishment, wherein the kiosk may include: the publishing module, the media purchasing module, and/or the media manufacturing module.

It may also be the present inventive method of retail publishing includes a step of providing a computer usable medium readable by a computer that may tangibly embody a program of instructions executable by a computer to perform method steps for providing retail publishing, said method steps comprising: providing a selection of media; restricting visibility of a portion of the selection of media according to a first rule, thereby creating a first unrestricted selection of media; creating publishing information from the unrestricted selection of media, the publishing information configured to instruct production of a media token; and/or creating licensing information configured to request licensing of licensable media referenced in the publishing information and used in making the media token.

More, according to one embodiment, the step of providing a computer usable medium readable by a computer may further comprise the steps of: requiring inclusion of a media element in publishing information, wherein the media element may not be hidden when included in the media token; and/or providing a media purchasing module that may restrict access to a media manufacturing module.

Still more, according to one embodiment, the step of providing a computer usable medium readable by a computer may further comprise the steps of: restricting media visibility according to a second rule that may form a second unrestricted selection of media; and/or altering a required media element.

Further, according to another embodiment of the inventive, the step of providing a computer usable medium readable by a computer may further comprise the step of: providing a media content management module in communication with a media licensing module and including a selectable set of rules having a plurality of modes wherein access to the media content provider network may be restricted.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a block diagram of a retail publishing system and method according to one embodiment of the invention;

FIG. 2 is a block diagram of a retail publishing system and method according to one embodiment of the invention;

FIG. 3 is a flow chart diagram depicting a method of retail publishing according to one embodiment of the invention;

FIG. 4 is a flow chart diagram depicting a method of retail publishing according to one embodiment of the invention;

FIG. 5 is a flow chart diagram depicting a method of retail publishing according to one embodiment of the invention;

FIG. 6 is a block diagram of a retail publishing system according to one embodiment of the invention;

FIG. 7 is a block diagram of a retail publishing system according to one embodiment of the invention;

FIG. 8 is a block diagram of a retail publishing system according to one embodiment of the invention;

FIG. 9 is a block diagram of a retail publishing system according to one embodiment of the invention; and

FIG. 10 is a block diagram of a retail publishing system according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: show data, participant data; sponsor data; financial institution data; and/or like data useful in the operation of the present invention. As those skilled in the art will appreciate, any computers discussed herein may include an operating system (e.g., Windows NT, 95/98/2000, OS2, UNIX, Linux, Solaris, MacOS, etc.) as well as various conventional support software and drivers typically associated with computers. The computers may be in a home or business environment with access to a network. In an exemplary embodiment, access is through the Internet through a commercially-available web-browser software package.

As set forth in the specification, the system and method of the invention may facilitate the providing of information to participants through multiple media sources and may allow the player modules to receive information via similar multiple media sources. The multiple media sources may include, for example, chat room, radio, bulletin board, internet web pages, email, billboards, newsletters, commercials and/or the like. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneider, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, network, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

As used herein, “publish” and the like include designing media. Accordingly, wherein a consumer selects media from a list and/or determines a mode of presentation, the consumer is publishing.

As used herein, “purchase” includes an exchange of value for value, including but not limited to cash or the like for goods and/or services, leasing, renting, and etc.

As used herein, “media content” or “multi-media” comprises media types such as text, images, audio, and video that is processed, stored, and transferred over a computer network, Internet, etc. according to multi-media communications applications, protocol, and standards.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

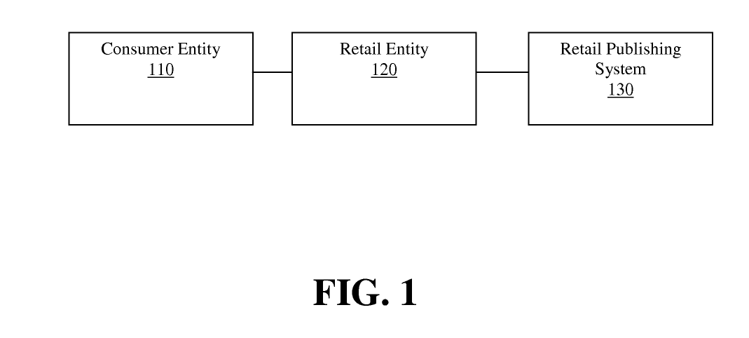

FIG. 1 shows a retail publishing system in operation according to one embodiment of the invention. There is shown a retail publishing system 130 in communication with a retail entity 120 that serves one or more consumer entities 110. It is contemplated that the retail entity 120 (also referred to as retailer) may be one or more retail locations, a Website, a Web service, etc. In addition, the retail entity may be a for-profit organization such as a convention retail store or a not-for-profit organization such as churches, schools, city/state/federal government agencies, etc. Further, the retail entity 120 provides the consumer entities 110 the ability to publish media, such as but not limited to music CDs, movies, books, etc. and associated artwork, such as but not limited to CD decorations, CD/DVD covers/cases, book covers, and etc. Advantageously, the retail publishing system 130 enables a retail entity 120 to provide a consumer 110 with great creative freedom in making media, while providing the retail entity with controls and tools for establishing and controlling a competitive advantage.

In particular, the retail publishing system 130 provides retail entities 120 access to a substantial amount of media from which to choose/select in making publishing decisions. Access to this resource is provided to the retail entity 120 in a mode wherein the retail entity 120 may design controls/rules/themes whereby publishing options and/or decisions of consumers may be directed by the retail entity 120. Accordingly, this provides an opportunity for the retail entity 120 to enter a creative partnership with consumers 110 in creating media suited to both the consumer and to the business goals/strategy of the retail entity 120.

Some non-limiting examples of retail entities 120 that may subscribe to the retail publishing system 130 include, but is not limited to: music/video/gaming outlets; medical companies/hospitals; pharmacies; building product stores (i.e., Home Depot, Lowes, etc.); motorcycle manufacturers (e.g., Harley Davidson); automobile dealerships/manufacturers; financial investment companies, and other retail entities that may sell products/goods/service through the World Wide Web.

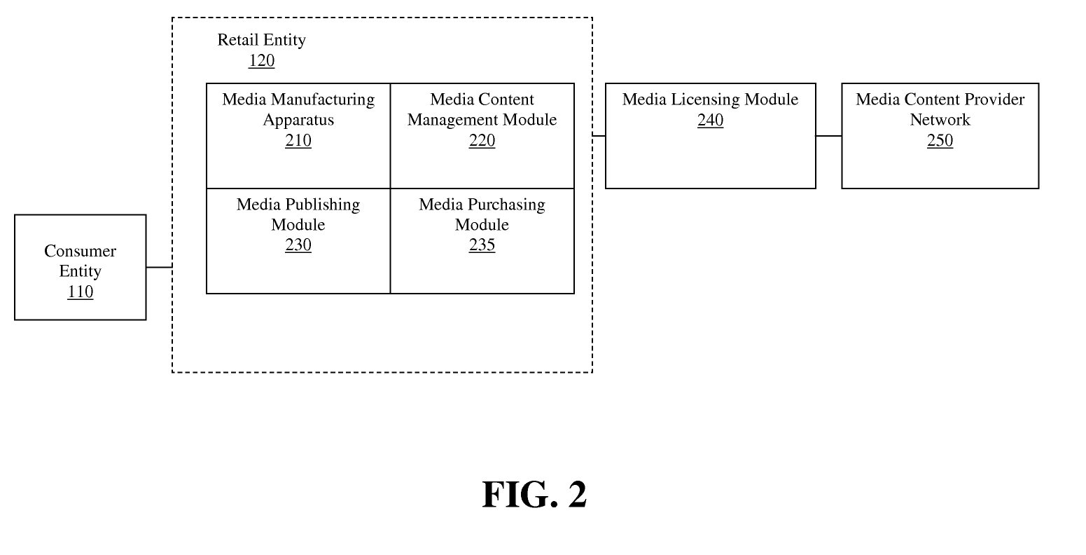

Further detail of one embodiment of the invention is illustrated in FIG. 2. There is shown a consumer 110 interacting with a retail entity 120, wherein the retail entity 120 provides access to a retail publishing system 130. The illustrated retail publishing system 130 includes: a media manufacturing apparatus 210, a media content management module 220, a media publishing module 230, a media licensing module 240, and a media content provider network 250. The illustrated media manufacturing apparatus 210, media content management module 220 and media publishing module 230 are shown in control of the retail entity 120 and one or more may also be physically present at a retail establishment. The illustrated media licensing module 240 and media content provider network 250 may be controlled by one or more third parties in partnership with the retail entity 120.

Some non-limiting examples of the media manufacturing apparatus or module 210, the media publishing module 230, the media content management module 220, and the media licensing module 240 employed by the retail publishing system 130 comprise desktop computer terminals/systems, such as Dell OptiPlex™ Desktops, Dell Dimension™ Desktops, etc. One skilled in the art would understand that said computer terminals/systems are designed/manufactured to include input/output (I/O) devices such as: hard diskette drives, printers, monitors, scanners, keyboards, mice, graphical user interfaces (GUI), etc. so that media content data may be processed, stored and/or transmitted by the computer system. Additionally, one skilled in the art would also understand that said computer terminals/systems may include communication modules, such as, but not limited to, wireless communications transceivers, microprocessors, telephone lines/jacks, modems, integrated circuits/chips, routers, etc. The particular modules 210, 220, 230, 240 depicted in FIG. 2 may be in analog and digital signal communications with each other in a LAN or WAN such that programs, text data, alphanumeric data, video data, graphical data, audio data, and other electronic data may be transferred back and forth amongst said modules.

According to one embodiment as illustrated in FIG. 2, the retail publishing system 130 further includes a media purchasing module 235 in communication with the media licensing module 240, and configured to receive media selection information, such as music media, video media, etc. and enable a purchase thereof with assistance from a retail clerk. Some non-limiting examples of the a media purchasing module 235 include: IBM Self-Checkout Device, IBM Personal Shopping Assistant, etc. Other embodiments of the invention may include a barcode scanner, such as an IBM Scanner Sure POS™ 4685/4698 USB, in electrical communication with the purchasing module 235 and configured to scan barcode disposed on a point of sale receipt or the like, representing the media selection information (also referred to as media content).

In one embodiment, a third party provides a retail publishing system 130 to a retail entity 120. The retail entity 120 configures one or more of a media content management module 220, a media publishing module 230, and a media manufacturing apparatus or module 210 in accordance with the desires, plans, business goals, marketing theme(s), and etc. of the retail entity 120. The retail entity 120 then provides access to the customers such that customers may purchase the media token(s) that may be published by the customer 110 (also interchangeably referred to as consumer entity or consumer). Non-limiting examples of the media token are objects including media, such as but not limited to CDs, DVDs, removable USB drives, removable memory devices, PDAs) that may be manufactured on demand (on-time manufacturing) at the point of purchase. The retail entity 120 may further configure one or more portions of the system as needed to further accommodate desires, plans, business goals, marketing theme(s), and etc.

The illustrated media publishing module 230 provides one or more tools to the consumer 110 for publishing media. Accordingly, the consumer 110 accesses the media publishing module 230 and makes design choices. Design choices may include but are not limited to: selecting media, selecting relationships between media portions, and designing new media. The media publishing module 230 facilitates design choices by providing access to a selection of media, such as by allowing a consumer to search, arrange, select, modify, or otherwise manipulate media files. Accordingly, a consumer may design a CD from scratch, including searching for and selecting artists and songs, choosing images to be displayed on a CD cover, and etc.

In one embodiment, the media publishing module 230 may also facilitate or otherwise automate one or more aspects of publishing. There may be automated functions carried out according to design choices made by a consumer 110. For example, a consumer may enable a function wherein as songs are selected a song list is populated and automatically placed on a back cover of a booklet being designed, while song lyrics are automatically included on pages within the booklet being designed.

In another embodiment, a media publishing module 230 may provide a retail entity 120 an opportunity to collaborate or otherwise contribute to design choices of a consumer 110. There may be one or more design choices that may be pre-selected by a retail entity. Accordingly, a consumer may publish in collaboration with the retail entity. Advantageously, this allows a retail entity to distinguish itself over other entities and/or otherwise provide a theme or rule-set for media produced therein. As one example, a media retailer having a particular color theme may restrict colors available for backgrounds on covers of books and CDs created therein, such that a consistent theme is produced as customers create media tokens. In another example, a retail logo or brand name may be required to be visibly/audibly included (not hidden) in media tokens created therein. Such logos may be selectably placed by a consumer 110 as desired, according to a set of pre-selected dispositions, according to a single pre-selected disposition, size, color, characteristic, and etc.

Non-limiting examples of products/media information that the retail entity 120 may permit the consumer entities 110 to access from the media publishing module 230 may include, but not be limited to: concert tickets; media product downloads, offerings, and coupons; special offers music products on-demand (e.g., musical CDs/DVDs with pictures of producers/artists disposed thereon, new releases, legacy products, personalized songs, etc.); video CDs/DVDs showcasing scenes of movies, new releases, news programs, sporting events; electronic books on demand for educational/recreational reading; local church directories; Bible Sermons on-demand; electronic gift cards; personalized/customized greeting cards on CD/DVD, etc.; computer games (i.e., video games, Bible games, Mediashout/Prologue presentation software, etc.); financial investment media; and other media products as desired by the retail entities 120 that subscribe to the retail publishing system 130.

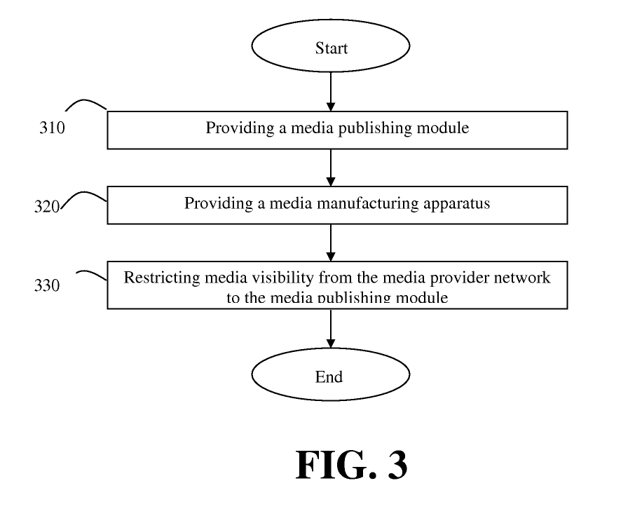

As shown in FIG. 3, according to one embodiment, parties employing the retail publishing system 130 may provide 310 a media publishing module 230 to a retail entity 120 such that said retail entity may have access to a media content provider network 250 through the media licensing module 240; provide 320 a media manufacturing apparatus 210 in communication with a media publishing module, configured to manufacture a media token, according to publishing instructions defined by the retail entity from the media publishing module; and restrict 330 media visibility from the media provider network to the media publishing module.

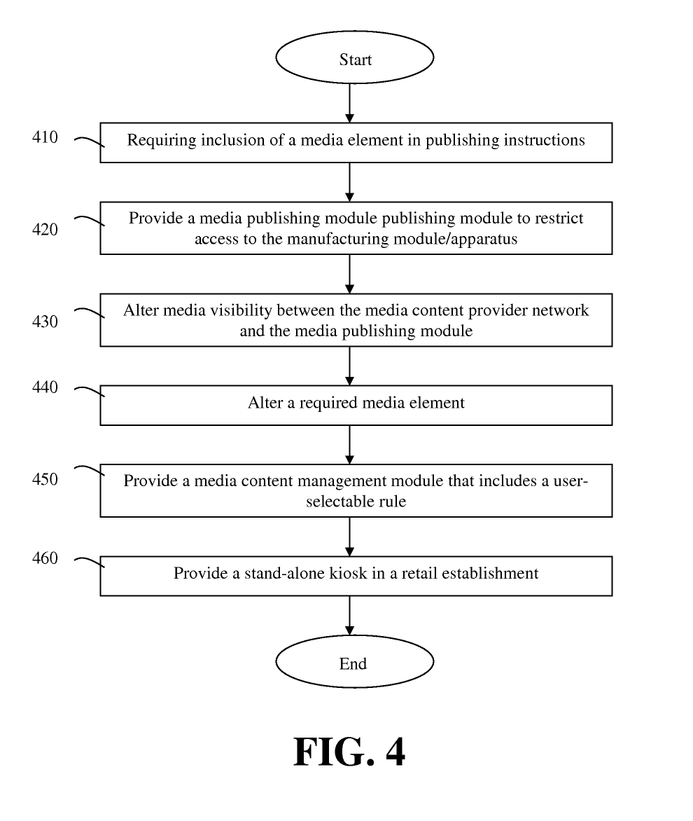

As shown in FIG. 4, in operation of the retail publishing method, according to one embodiment, the retail entity 120 may require 410 inclusion of a media element, such as a trademark logo/symbol, product brand name/design, copyright text/symbol, etc. in publishing instructions, wherein the media element may not be hidden when included in the media token generated by the media publishing module; provide 420 a non-limiting example of a media purchasing module 235 such as described in U.S. Pat. No. 7,188,154 , issued to Minowa, which is incorporated by reference herein, that may restrict access to the media manufacturing module 210; alter 430 media visibility between the media content provider network 250 and the media publishing module 230; alter 440 a required media element, such as when the retailer 120 desires to change the location, position, shape, etc. of a product brand name/design, trademark logo, etc. disposed on the media; provide 450 a media content management module 220 in communication with a media licensing module 240 that includes a user-selectable rule, such as a list of prohibited or undesired media content/information having a mode wherein access to the media content provider network may be restricted.

Restriction by a module of access to another module or to content therein may be simply accomplished through a metadata tag set to such module or data therein, wherein access may be conditionally provided based on a value of such metadata. For example, a manufacturing module access address may have a purchase data element that may be set to a certain value before a purchase is made, a value whereupon access is denied, and the media purchasing module 235 may be configured to alter such a value to one wherein access is granted upon satisfaction of a purchase condition. It is understood that one skilled in the art would recognize that the number of ways to control such access and/or to otherwise restrict/allow operation/communication/access between modules and among data structures are plethoric.

In one embodiment, a retail entity 120 may provide 460 a stand-alone kiosk as described in U.S. Pat. No. 7,188,154 issued to Minowa, which is incorporated by reference herein, in a retail establishment, wherein the kiosk may be configured to collectively include: the media publishing module 230, the media purchasing module 235, and the media manufacturing module 210. This may enable the consumer 110 and/or retail entity 120 to conveniently order, pay for, and manufacture desired media from a “one stop shop” location.

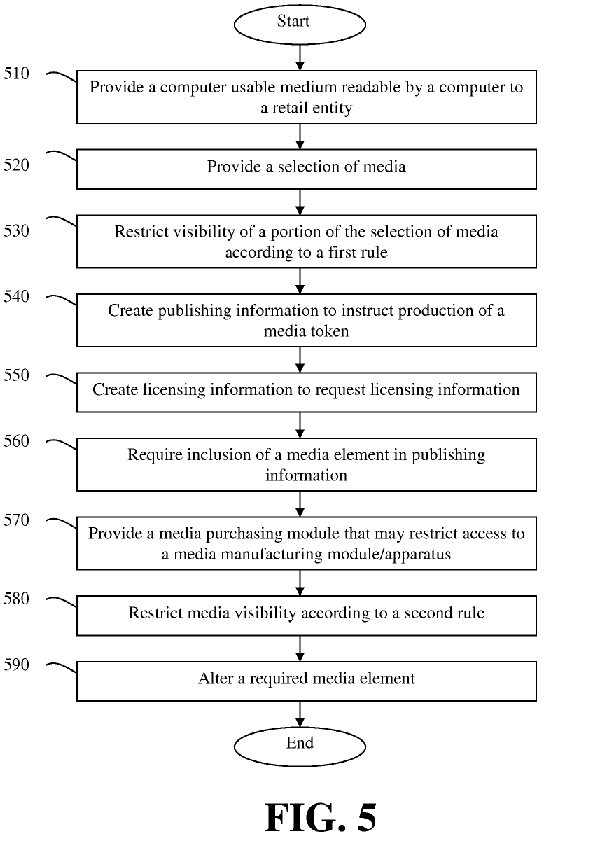

As shown in FIG. 5, in operation of a retail publishing method, according to an alternative embodiment, the parties managing the retail publishing system 130 may provide 510 a computer usable medium readable by a computer to a retail entity 120 that tangibly embodies a program of instructions executable by a computer to perform the following retail publishing steps: provide 520 a selection of media; restrict 530 visibility of a portion of the selection of media according to a first rule, wherein the retailer may limit objectionable media content 670 (e.g., X rated movies/videos) thereby creating a first unrestricted selection of media; creating 540 publishing information from the unrestricted selection of media, wherein the publishing information is configured to instruct production of a media token; create 550 licensing information configured to request licensing of licensable media referenced in the publishing information and used in making the media token; require 560 inclusion of a media element, such as a video watermark, trademark logo, etc., in publishing information, wherein the media element may not be hidden when included in the media token; provide 570 a media purchasing module that may restrict access to a media manufacturing module; restrict 580 media visibility according to a second rule, wherein the consumer may limit objectionable media content 670 (e.g., country music) that may form a second unrestricted selection of media; and alter 590 a required media element.

For example, the retailer publishing instructions may call for retailer logos to be automatically positioned on the foreground of clip art, graphic information disposed on the media such as CD, DVD, etc. selected by the consumer. Non-limiting examples of publishing information may include selected graphics of artists, listing of sound tracks, etc. Some non-limiting examples of licensing information may include trademark logos of the retailer, copyright symbols/text of the retailers, etc.

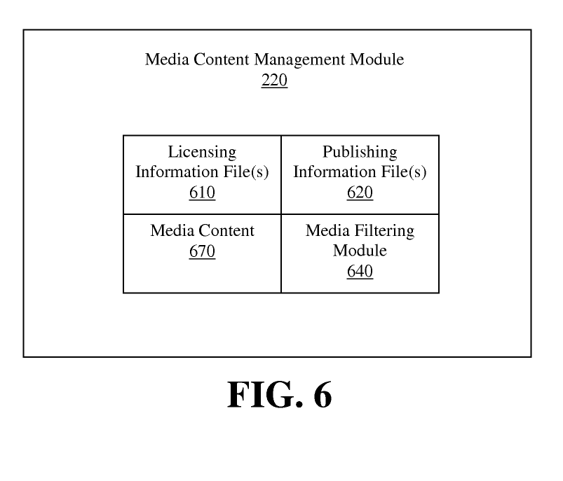

As shown in FIG. 6, according to one embodiment, a media content management module 220, such as an IBM Remote Management Agent (RMA) V2.00, is configured to provide retailers with a capability of controlling, managing, collecting and filtering retail products, e-business transaction documents, and other media content 670. One skilled in the art may understand that the media content management module 220 may be a computer server having kiosk system security administration software installed therein, as well as licensing information file(s) 610 and publishing information file(s) 620 stored therein. Non-limiting examples of content that may be contained in the licensing information file(s) 610 may include: electronic licenses from a plurality of media providers allowing retailers to copy, re-produce, or generate a plurality of media with the guidelines of the license/copyright laws, a list/index of copyright holders, trademark/service mark owners, content service providers, etc. Some non-limiting examples of content that may be contained in the publishing information file(s) 620 may include: clip art, pictures of artists, pictures of retail logos, product brand names, an list/index of multi-media content, etc.

More, the media content management module 220 also includes a media filtering module 640 such as described in U.S. Pat. No. 6,476,833, issued to Moshfeghi, which is incorporated by reference herein, configured for a retail entity 120 to selectably pass or reject media disposed on an Internet Browser that may be available from the media content provider network 250, contrary to the business goals of the retailer. In operation, the retail entity 120 may selectably manipulate the media filtering module 640 to filter markup language documents such as HTML, XML, etc. before being displayed on an Internet browser in order to delete linking media content 670, publishing information 710 and/or licensing information 720 that is not allowed by the retail entity 120. In an alternative embodiment, the filtering module 640 may be configured for retailers 120 to filter out undesirable Internet radio songs, such as those provided by Yahoo, Inc. for example. This would preclude consumers 110 from listening to such prohibited songs from the media publishing module 230. For example, retailers targeting the children market may filter our undesired Internet songs (e.g. rap music) from being listened to consumers 110 purchasing music CDs for children.

In one embodiment, the media content management module 220 provides the retail entity 120 control over media accessible by a media publishing module 230. The media content management module 220 includes a selectable rule, wherein the selectable rule may comprise one or more Internet file transfer protocol (FTP) download scheduler software program that enables the retail entity to employed automated means to selectably schedule the downloading of files to the media content management module 220, thereby restrict access to media content provided by a media content provider according to the following characteristics: time, date, genre, rating, artist, license holder, etc. Accordingly, a retail entity 120 having access to a media content provider network 250 may restrict access thereto by a media publishing module 230. Such restriction may be embodied in not allowing the publishing module access to or even awareness of particular media types, genres, artists, labels, copyright license holders, license terms, time, date, rating, artist, and/or according to any other characteristic of the media.

In operation of one embodiment of the media content management module 220, the retailer 120 may restrict access to media content 670 after a predetermined time. For example, a music retailer 120 closing every day at 6:00 PM may configure the filtering module 640 to reject passes of music media content 670 from the media content management module 220 to the media publishing module 230 such that would be burglars may not enter the retailer and illegally download music and/or otherwise produce music media.

In operation of another embodiment of the media content management module 220, the retailer 120 may restrict access to media content 670 after a predetermined date. For example, a music retailer 120 desiring to discontinue the sale of Christmas Music after a date of December 31st of a given calendar year, may configure the filtering module 640 to reject passes of Christmas music after said date, wherein a consumer 110 may not custom select Christmas music CDs/DVDs from the media publishing module 230. The retail entity 120 may decide to do so since selling Christmas music may no longer be a part its business goals after said date.

In operation of yet another embodiment of the content management module 220 the retailer 120 may restrict access to media content 670 according to the rating of video/movie content. For example, a children entertainment retailer may configure the filtering module 640 to reject all rated “R” movies/videos and pass only rated “G” and “PG” movies/videos, such that only rated “G” and “PG” movies/videos may be accessed from the retailer's location.

Advantageously, a retail entity 120 may be enabled to tailor available media content 670. In one embodiment, a religious bookstore offering the ability to produce universal serial port (USP) key chains having inspirational audio messages included may be able to access a system including adult rated comedy routines but restrict media publishing module(s) 230 from even showing such as an option. Thereby a huge network may be provided to all retail entities, while enabling such to limit availability to content as desired.

Some non-limiting examples of products/information a retail entity 120 may access from the media content management module 220 include: consumer email messages; consumer buying patterns; customized store maps; inventory management documents; employee management data (i.e., policies, notices, job postings, product/service training, etc.); filtered websites/documents, and information that may viewed from the media publishing module.

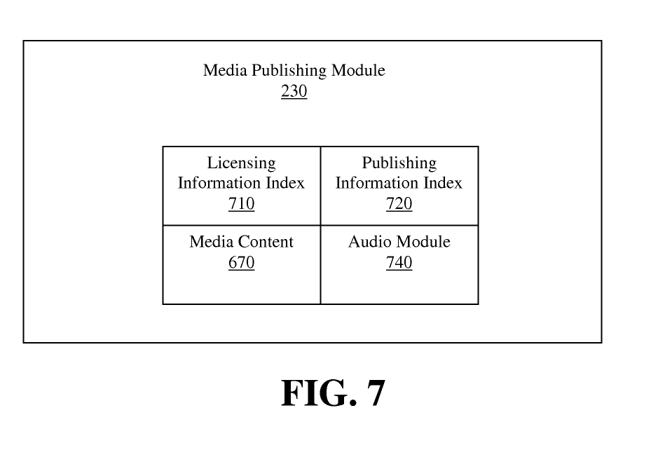

In another embodiment, FIG. 7 shows a media publishing module 230, such as a client workstation, configured to be staged in a retail establishment and available for a user to view/select media content 670 that comprises media types, genres, artists, labels, etc. collectively listed in a licensing index 710 and publishing information index 720, respectfully. In one embodiment, the publishing information index 720 may comprise a Web Service which takes an order number from the consumer 110 and sends the media to the consumer by means of the Internet, WAN, LAN, etc. Additionally, it is contemplated that the media publishing module 230 may comprise one or more computer software/hardware program(s) running on a computer device, such as a computer terminal, kiosk, website, etc. or a collection of thereof networked together.

Further, the media publishing module 230 includes a media token generation module 730, etc. coupled thereto. According to one embodiment, a non-limiting example of the media token generation module is part of a kiosk, such as Sure POS™ 700 Series manufactured by IBM Corporation, 1 New Orchard Road, Armonk, N.Y. 10504-1722. One skilled in the art may appreciate that the kiosk is configured to print out a media token, upon selection of media, wherein said token is configured to be a visual confirmation of selected media and estimated cost for purchasing the media. Moreover, the media publishing module 230 includes an audio module 740, such as speakers, microphones, sound card, etc. that enables the consumer 110 to listen to a sample of media sound effects, speech patterns, voice recognition, etc. from the licensing information index 710 and publishing information index 720 prior to him or her making a media selection and/or purchase decision.

In operation of one embodiment of the media publishing module 230, it is assumed that the retail entity allowed the consumer 110 to have access to the selected media content 670 therefrom. The consumer 110 may view and/or listen to media by means of a GUI and employ a computer mouse to “point and click” on the desired media content to make a selection. After making desired selection, the media publishing module 230 may instruct a kiosk printer such as an IBM 4689 POS™ Printer TDS to print out the media token showing the selected media content 670 and estimated cost for the selected media content 670. The consumer 110 may then insert the media token into the media manufacturing apparatus 210 in order to have a media product manufactured.

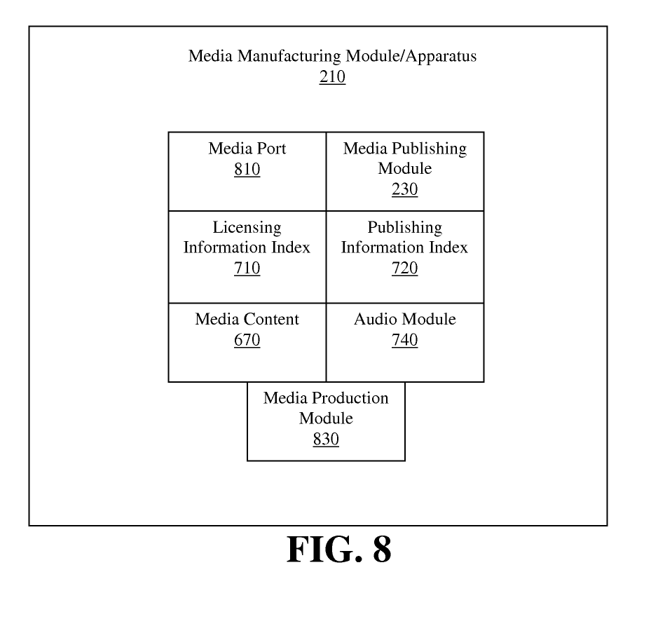

In one embodiment shown in FIG. 8, the present inventive retail publishing system 130 includes a media manufacturing module or apparatus 210 configured to manufacture media products according to publishing instructions at the media publishing module 230. A retailer operating the apparatus may input media, such as CDs, DVDs, cassette tapes, etc. into a media port 810, such as a CD/DVD-ROM drive aperture wherein a CD/DVD-ROM may be inserted therethrough so that the media production module 830, such as readable/rewriteable CD/DVD burner configured to bum media content, such as audio files, music files, video artists/data, images, text, electronic books, etc. listed on the publishing information index 720. Further, the retail entity 120 may check the licensing information index 710 from the apparatus 210 to access a list of licensing agreements by artist name so as to verify that he or she is authorized to reproduce the media content 670 on a media in accordance with the agreements, copyright laws, trademark laws, etc. prior to producing a finished media product for the consumer 110.

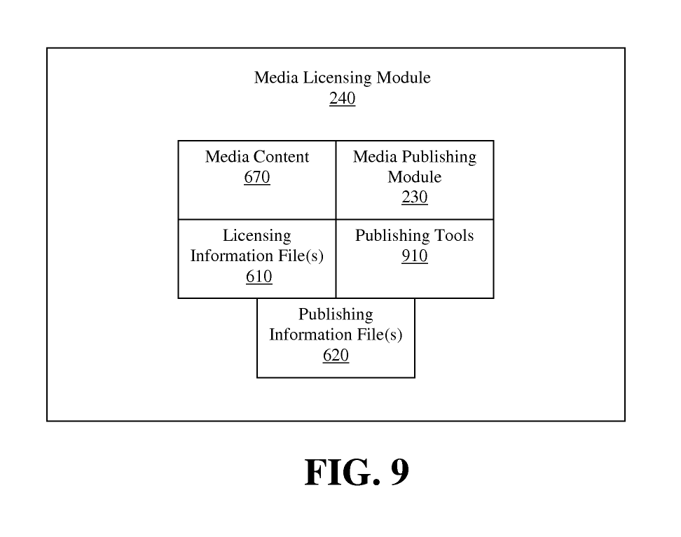

FIG. 9 shows an embodiment of a media licensing module 240 configure to store licensing information file(s) 610, such as licensing agreements, trademark/service mark agreements and publishing information file(s) 620 containing information pertaining to media content provider logos, brand names, contact information, accounting information, etc. In one embodiment, the media publishing module 230 is a desktop computer terminal that is part of a kiosk system and includes a plurality of publishing tools 910, thereby enabling the consumer 110 to customize or personalize greeting cards and other design labels as desired to identify media content. Non-limiting examples of publishing tools 910 may include: Microsoft® Windows Vista™, Sherif In Education software, Adobe InDesign CS2 software, Web Plus 10, Photo Plus 11, Draw Plus 8, and other desktop publishing software programs that may be installed on the media publishing module 230. In another embodiment, the media licensing module 240 is configured for parties operating the retail management system 130 to selectably distribute media content to the media content management module 220 upon request from the retail entity 120 via transfer protocol (FTP) over the Internet highway. In turn, the retail entity 120 may ensure redistribution of the media content 670 over the LAN or WAN to the media publishing module 230 so that the consumer 110 may have access to the media content 670 in order to make media purchasing decisions.

Advantageously, parties operating the system 130 may employ the media filtering module 640 upon request from the retail entity, according to an agreed upon fee structure, to selectably restrict the transfer of media content 670, licensing information file(s) 610, publishing information file(s) 620 from the media content providers so that the selected media content 670 would not be available at any given retail location, thereby denying the consumer 110 access to the media content 670 from the media publishing module 230 in cases where having the media in its inventory is contrary to successful execution of its business goals/strategy.

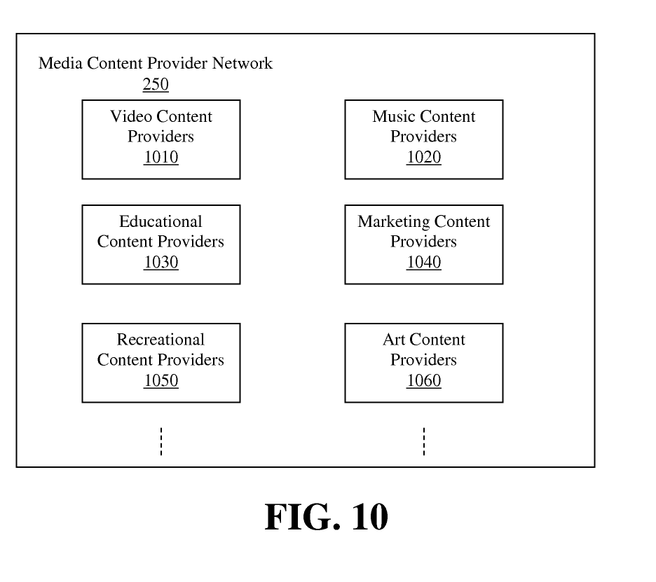

According to one embodiment as shown in FIG. 10, the media content provider network 250 comprises a plurality of media content providers that may include but not be limited to: video content providers 1010, such as video.aol.com, itunes.com youtube.com, etc. the provides media pertaining to video images; music content providers 1020, such as musiwave.net, ntt.net, itunes.com, etc. that provides media pertaining to music; educational content providers 1030, such as blendschools.net, cilc.org, elvnnetwork.com, etc. that provides electronic books to stimulate a user's educational needs; marketing content providers 1040, such as google.com, ckmg.com, yourwriters.com, etc. that provides media content in the form of product/service advertisements, special offers, coupons, etc.; recreational content providers 1050, such as parksandcampgrounds.com, websition.com, amhertguide.com, etc., the provides media pertaining to leisure activities people may enjoys; and art content providers 1060, such as metmuseum.org, artcyclopedia.com, philamuseum.org, etc., that provides media content in the form of artistic displays, paintings, etc.

In still yet even a further embodiment of the invention, the media manufacturing apparatus 210 and the media publishing module 230 may include an adapter module configured to enable media content to be downloaded to an MP3 player, iPOD, or another portable electronic device. Some non-limiting examples of an adapter module may include a USB cable, LAN cable, etc. that enables the MP3 player, iPOD, etc. to be coupled to, and in communication with to said modules 210, 230.

It is contemplated that the media content provider network 250 may comprise: one or more Websites, one or more Web services, a satellite communications feed, a CD/DVD ROM running on a computer at the retail site, an IVR system (touchtone phone system), a call center as non-limiting examples.

One skilled in the art may envision that the parties operating the retail system 130 may employ the media licensing module 240 to function as an intermediary between the retail entities 120 and media content providers in the media content provider network 250, wherein the parties may control the flow of media content 670, publishing information file(s), licensing information file(s) to the retail entities according to established contract agreements, media content license agreements, etc. Further, according to one embodiment, the parties operating the retail system 130 may facilitate the transfer of media content fees paid by the consumer 110 by means of the purchasing module 235 from the retail entity to the media content providers in the media content provider network 250 according to fee structure/schedules determined by the media content providers.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For the purposes of operating the invention, it is contemplated that the retail entity may be one or more retail locations, a Website, a Web service, etc. In addition, the retail entity may be a for-profit organization such as a convention retail store or a not-for-profit organization such as churches, schools, city/state/federal government agencies, etc.

Additionally, for the purposes of operating the invention, it is also contemplated the consumer or consumer entity 110 may be an individual, a retail entity, a business organization, and/or a system attached to the media publishing module 230 through a Website, Web service, LAN, WAN, FTP site, etc. A non-limiting example of a consumer 110 being a system may be an automated ordering system for replenishing inventory. A non-limited example of the consumer 110 being a retail entity 120 may the case where the retailer is a operating as a back end fulfillment office for a website.

Moreover, it is contemplated that the media manufacturing apparatus 210 may be: CD/DVD-ROM burner, a printing system, and/or a computer device with USB, fire wire ports, wired or wireless connection to a client device, wherein the downloading electronic media to laptops, personal digital assistants (PDAs), MP3 players, iPODs, phones etc. may be accomplished.

Further, it is contemplated that the media content management module 220 may be a software or hardware program running either at the retail site or off site. For example, a retail store may have a media content management module 220 running on a server at a third party owned hosting location. Content for all sites could be managed at the one location. Each retail site could connect to the hosted server via internet, web service over a LAN, WAN, etc.

It is envisioned that one skilled in the art of computer/multi-media technology would understand that either the media manufacturing apparatus 210, the media content management module 220, and/or media publishing module 230 may be operated as a stand-alone desktop system and/or collection of interconnected systems for selecting, ordering, purchasing, manufacturing and/or delivering media content to the consumer 110.

It is also envisioned that the licensing information index 710 may be combined with the publishing information index 720 or separate from it, and include the following non-limiting examples: printed catalogue with ordering number and pricing information, Website, Web service, CD/DVD-ROM index, satellite feed, television channel, etc. based on various modes of operating the present invention.

It is expected that the media manufacturing apparatus 210, media content management module 220, media publishing module 230, and/or media licensing module 240 may comprise portable/laptop computer systems in lieu of desktop systems, wherein one skilled in the art may understand that the functionally of the invention can still be accomplished.

It is further expected that there may be more media content providers, in addition to the six media content providers shown in FIG. 10, included in the media content provider network 250 according to various embodiments/modes of operating the present invention. For example, additional media content providers may include, but not be limited to: financial services providers, health service/product providers, beauty/hygiene product/service providers, food/nutrition product/service providers, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A retail publishing system for enabling desktop publishing in a retail setting, comprising:
a media content provider network configured to provide media content from a plurality of sources;
a media content management module in communication with the media content provider network and including a selectable rule having a mode wherein access to the media content provider network is restricted;
a media manufacturing apparatus in communication with the media content management module and configured to receive media therefrom and to produce a media token having media disposed thereon; and
a media publishing module in communication with the media content management module, providing access to media from the media content provider network and enabling selection of media thereby forming media selection information deliverable to the media manufacturing apparatus.

2. The retail publishing system of claim 1, further comprising a media purchasing module in communication with a media licensing module and configured to receive media selection information and enable a purchase thereof.

3. The retail publishing system of claim 2, wherein the selectable rule restricts access according to a characteristic from the list of characteristics including time, date, genre, rating, artist, and license holder.

4. The retail publishing system of claim 3, wherein the media publishing module includes a publishing rule having a mode wherein a required media must be included in the media selection information

5. The retail publishing system of claim 4, wherein the media publishing module enables modification of media and produces modified media information.

6. The retail publishing system of claim 5, further comprising a media licensing module in communication with the media content provider network and configured to manage access to the media content provider network.

7. The retail publishing system of claim 6, further comprising a media purchasing module in communication with the media publishing module and configured to enable a consumer to purchase media according to publishing information.

8. A method of retail publishing, comprising the steps of:
a) providing a publishing module having access to a media provider network through a media licensing module;
b) providing a media manufacturing apparatus in communication with the publishing module and configured to manufacture a media token according to publishing instructions from the publishing module; and
c) restricting media visibility from the media provider network to the publishing module.

9. The method of claim 8, further comprising the step of requiring inclusion of a media element in publishing instructions, wherein the media element is not hidden when included in the media token.

10. The method of claim 9, further comprising the step of providing a media purchasing module restricting access to the media manufacturing module.

11. The method of claim 10, further comprising the step of altering media visibility between the media provider network and the publishing module.

12. The method of claim 11, further comprising the step of altering a required media element.

13. The method of claim 12, further comprising the step of providing a media content management module in communication with a media licensing module and including a selectable rule having a mode wherein access to the media content provider network is restricted.

14. The method of claim 13, further comprising the step of providing a kiosk in a retail establishment, wherein the kiosk includes the publishing module, the media purchasing module, and the media manufacturing module.

15. A computer usable medium readable by a computer, tangibly embodying a program of instructions executable by a computer to perform method steps for providing retail publishing, said method steps comprising:
a) providing a selection of media;
b) restricting visibility of a portion of the selection of media according to a first rule, thereby creating a first unrestricted selection of media;
c) creating publishing information from the unrestricted selection of media, the publishing information configured to instruct production of a media token; and
d) creating licensing information configured to request licensing of licensable media referenced in the publishing information and used in making the media token.

16. The computer usable medium of claim 15, further comprising the step of requiring inclusion of a media element in publishing information, wherein the media element is not hidden when included in the media token.

17. The computer usable medium of claim 16, further comprising the step of providing a media purchasing module restricting access to a media manufacturing module.

18. The computer usable medium of claim 17, further comprising the step of restricting media visibility according to a second rule, thereby forming a second unrestricted selection of media.

19. The computer usable medium of claim 18, further comprising the step of altering a required media element.

20. The computer usable medium of claim 19, further comprising the step of providing a media content management module in communication with a media licensing module and including a selectable set of rules having a plurality of modes wherein access to the media content provider network is restricted.
